(19) United States
(12) Patent Application Publication
(10) Pub. No.: US 2013/0213382 A1
(43) Pub. Date: Aug. 22, 2013

(54) Gas Barbecue With Fuel Supply Valve Control

(71) Applicant: Phillip R. Barber, Kalamazoo, MI (US)

(72) Inventor: Phillip R. Barber, Kalamazoo, MI (US)

(21) Appl. No.: 13/746,452

(22) Filed: Jan. 22, 2013

Related U.S. Application Data
(60) Provisional application No. 61/589,269, filed on Jan. 20, 2012.

(51) Int. Cl. A47J 37/07

(52) U.S. Cl. CPC A47J 37/0713
USPC 126/25 R

(57) ABSTRACT

A gas barbecue grill with mechanism to control the fuel supply valve handle is herein provided having a fuel supply with an existing valve operated with a handle and, a hand operable rotary control handle located in or near the barbecue grill control panel and, a plurality of rotatably, pivotably, slidably operable drive shafts, geared drive shafts, grooved drive shafts, beveled gearwheels, gear wheels, retainer collars, bearings contiguously connected so as to contiguously transfer hand actuated rotating motion from the rotary control handle located near the barbecue control panel to the socket slidably engaged to the fuel supply valve handle, thereby operably rotating the fuel supply valve handle variably to the open on and closed off position.

### BACKGROUND OF THE INVENTION

The present invention relates to gas barbecue grills and more particularly to gas barbecue grills with fuel supply valve control.

Barbecue grills are well known, and have grown in popularity in recent years. Over the years there have been numerous improvements made to grills. There are two primary types of barbecue grills commonly used gas grills and solid fuel grills. Gas barbecue grills employ a gas burner element or group of burners to cook food that is supported on a grate above the burner(s). The fuel supply for gas barbecue grills is typically liquid propane or natural gas that is stored for use in a fuel tank with an integrated valve and handle or larger tanks with external valves & handles attached with pipes, conduits and fittings.

Solid fuel barbecue grills use combustible solid fuel, typically charcoal, to cook the food. As a result, this type of grill is commonly referred to as a charcoal barbecue grill. Regardless of the type, most barbecue grills have a cooking chamber that generally includes a firebox, firebox lid, a stand, cart or cabinet.

With respect to gas barbecue grills, the fuel tank with an integrated supply valve and handle is the common variety of the fuel supply utilized with most portable, stationary and semi-stationary barbecue grills, connection to larger fuel tanks and natural gas pipe lines are made by use of a conduit or pipe and fittings, controlled by an inline supply valve.

Generally, gas barbecue grills consist of a frame or support structure and a cooking chamber. Grills can be configured to hold or support the heating elements and a fuel tank on the side or inside a cabinet.

Gas gills have a burner element adjacent to the lower portion of the chamber with a cooking surface near the top of the chamber. Gas grills almost universally have a hood or cover which can be lifted up or pivoted to permit access to the cooking surface. There can also be an auxiliary cooking element located inside or on the side of the grill for cooking

Conventional gas barbecue grills do not include any mechanism to turn the fuel tank valve handle on or off from a safe and convenient location. Thus the user is forced to stoop, bend down, reach over, and place their face, hands, arms and other body parts in dangerous proximity to the burning hot firebox near the fuel tank valve handle endangering the user of severe burn to their body. Not easy for the physically challenged.

Originally gas barbecue grills were simply connected to the fuel tank valve. However problems resulted because the fuel tank valve handle was commonly located in unsafe, inconvenient, and obscure locations on the barbecue grill. Consequently the fuel tank valve is often left in the on or open position after use, and the conduits, tubing, valves, fittings, and burners in the barbecue grill deteriorate and leak over time causing fuel to pour out from the unclosed fuel tank valve, and that the barbecue grill burner valves would not always be completely turned to the off or closed position after use causing un-extinguished fire to continually burn unintentionally, and that unintended fire caused by worn conduits, tubing, valves, fittings, and burners in the barbecue grill burn out of control with an uninterrupted fuel supply; these problems thereby causing fuel waist, environmental pollution, hazard of unintended fire, and undue risk to bodily injury.

The below-referenced U.S. patents, disclose embodiments that were at least, in part, satisfactory for the purposes for which they were intended. The disclosures of the below referenced prior United States patents in their entireties are hereby expressly incorporated by reference into the present application for purposes, including, but not limited to, indicating the background of the present invention and illustrating the state of the art.

U.S. Pat. No. 5,628,242, and U.S. Pat. No. 4,823,838, are examples however they simply do not posses the safety, economy, ergonomic ease of use, convenient location of controls, the user friendly means of operation being readily apparent to the user, the reliability of use offered by sturdy mechanical parts, and the low cost of production as the present application for patent disclosed herein.

U.S. Pat. No. 5,628,242 (May 13, 1997) titled: Gas grill with automatic shut off controlled by dynamic sensor, discloses an activity monitor with a motion detector, when the grill has not been used for a pre-selected time period, the gas supply is automatically shut off.

This patent attempts to solve the need for improved gas barbecue fuel tank valve control by a complicated and expensive electro-mechanical device, however this is a far more complicated, expensive. and less effective method than the patent disclosed herein.

### SUMMARY OF THE INVENTION

A main advantage of the present invention is providing an improved gas barbecue grill with mechanism to control the fuel supply that attempts to solve the problems of conventional gas barbecue grills detailed herein by incorporating one or more of the characteristics discussed in the embodiments listed below.

A preferred embodiment of the gas barbecue grill with mechanism to control the fuel supply valve handle comprising: a gas barbecue grill, a fuel supply having an existing valve operated with a handle; a hand operable rotary control handle located in or near the barbecue grill control panel; a plurality of rotatably, pivotably, slidably operable drive shafts, geared drive shafts, grooved drive shafts, beveled gears, gears, retainer collars, & bearings contiguously connected so as to contiguously transfer hand actuated rotating motion from the rotary control handle located near the barbecue control panel to the socket slidably engaged to the fuel supply supply valve handle, thereby operably rotating the fuel supply supply valve handle variably to the open on and closed off position; and a socket formed so as to engage the fuel supply valve handle releaseably into the socket.

The inventive grill can be integrated into a cabinet, counter island wall or mobile unit either indoor or out outdoors.

Accordingly, beside the advantages described above several advantages of one or more aspects of the present invention are as follows:

(a) it is a more safe gas barbecue grill with mechanism to remotely control the fuel supply valve handle to and from an on or off position from a more safe location. Solving the problem of the barbecue grill user being forced to kneel, bend down, stretch over and place their face, hands, arms and other body parts in dangerous proximity to the barbecue grills' burning hot firebox in order to operate the fuel tank valve handle, providing the advantage of reduced user burn and strain to body parts over conventional gas barbecue grills, an important improvement to the elderly and physically challenged.

(b) it is a more convenient gas barbecue grill with mechanism to remotely control the fuel tank valve handle to an on or off position from a more convenient location. Providing the advantage of a more visible, obvious and more convenient fuel supply valve control over conventional gas barbecue grills.

(c) it enables a more efficient gas barbecue grill by increasing on/off use of the fuel supply valve before and after use thereby preventing fuel loss from, burner valves being left on in the open position after use, and through worn, defective or otherwise leaking valves, pipes, conduits and fittings leaking fuel when the barbecue grill is not in use, providing the advantage of a more efficient gas barbecue grill through reduced fuel loss and waist.

(d) it provides a gas barbecue grill that reduces hazard to unintended fires by increasing on/off use of the fuel tank valve before and after use, thereby solving the problem of hazard to unintended fire caused by the fuel tank valve being left in the open or on position after use by the user due to the fuel supply valves out-of-sight-out-of-mind, unsafe, inconvenient location. Providing the advantage of a barbecue grill with reduced hazard to unintended fires over conventional gas barbecue grills.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which drawings 1, 2 & 3 illustrate various views of embodiments of the present invention.

Referring now to drawings 1&2 it will be seen, the hand operably rotatable control handle 1, upwardly angularly disposed drive shaft 2, beveled gear wheel 3a, beveled gear wheel 3b, beveled gear wheel 3c, gear wheel 3d, horizontally disposed drive shaft 4, dowardly disposed drive shaft 5, operable drive shaft elongated grooves 5a, socket 6, phantom socket 6a, socket through-hole 6b, fuel supply valve 7, fuel tank 8, firebox 9, control panel 10, gas barbecue grill 11, valve handle 12, grill cart 13, supporting cross member 14, retainer collar & bearings 15, operable drive shaft grooves 16, barbecue gas burner valves 17, gas burner control handles 18, fire box lid 19; the affore described members being preferably formed of resilient plastic, metals or other suitable material.

In describing the preferred embodiment of the invention, which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word “slidably”, “connected” or terms similar thereto are often used. They are not limited to direct connection but include connection through other elements where such connection is recognized as being equivalent by those skilled in the art.

### DETAILED DESCRIPTION OF THE PREFERRED EMBODIMENT

The present invention and the various features and advantageous details thereof are explained more fully with reference to the non-limiting embodiments described in detail in the following description.

The present invention relates to preferably a gas barbecue grill, a gas barbecue, and a dual fuel grill with mechanism to remotely control the fuel supply valve handle.

The grill is preferably composed of a base grill chamber and base stand assembly. The base housing is attached to a grill housing or chamber or attached in a mobile unit, cart or to some other surface. Alternatively, the grill can be permanently fixed in an island, countertop or cabinet. The grill housing is preferably of a low depth extending into the base mobile housing assembly and is attached to the frame.

The gas barbecue grill fuel supply control mechanism hand operable rotary control handle can be integrated into the controls at the front, or parts of the controller mechanism can be split between the grill and other locations.

Various alternative embodiments and modifications to the invention will be made apparent to one of ordinary skill in the art by the following detailed description taken together with the drawings.

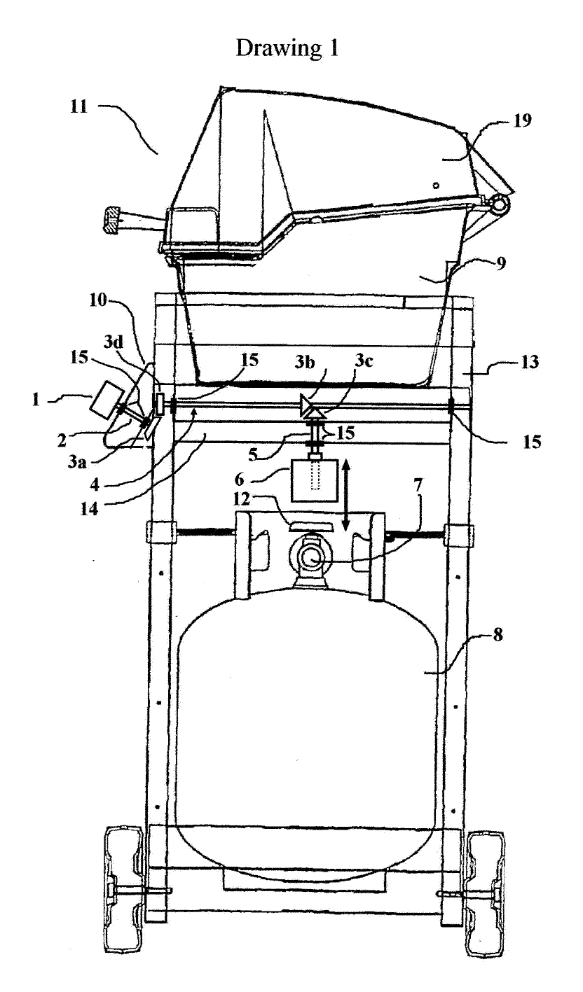

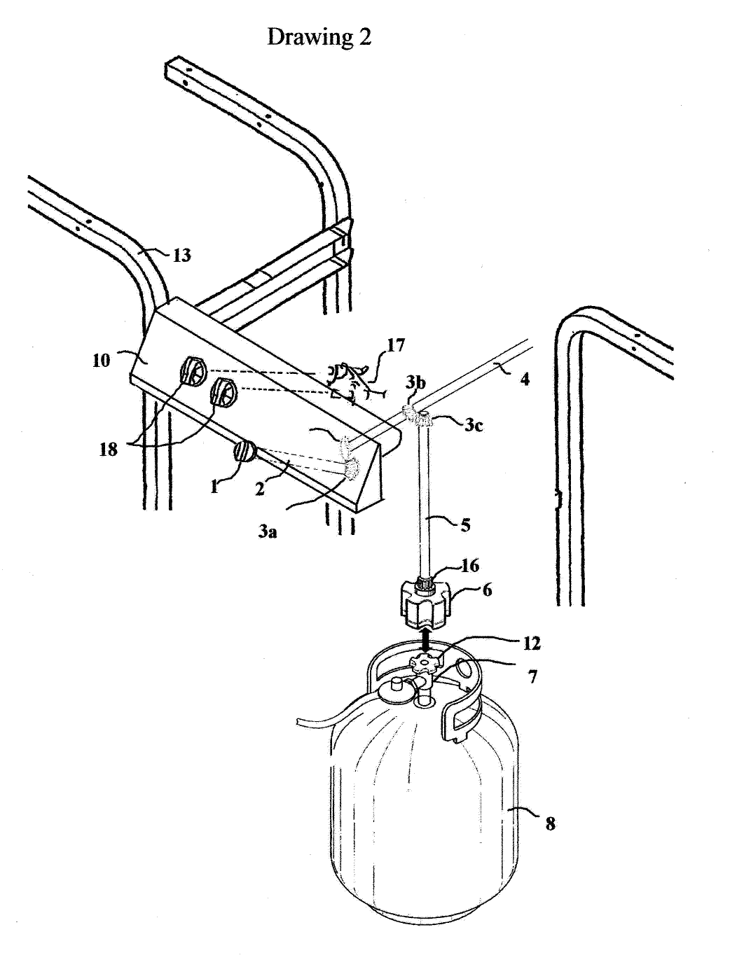

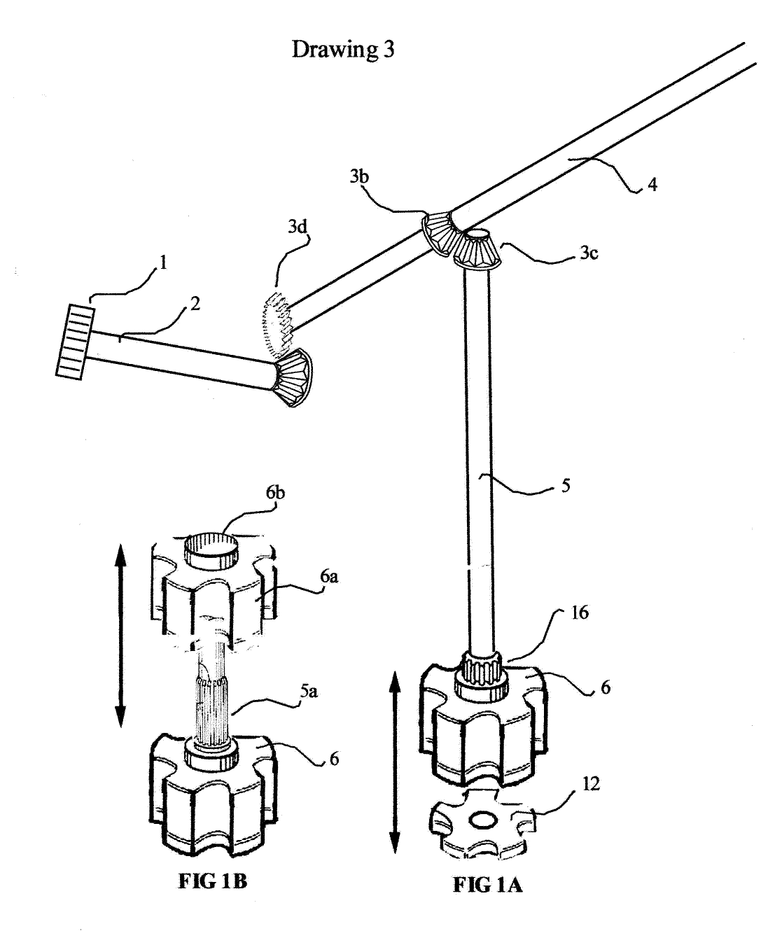

Referring again to FIG. 1 it will be seen a preferred embodiment of the invention; a grill made in accordance with the present invention 11, comprising: firebox 9, fire box lid 19, control panel 10, fuel tank 8, with supply valve 7, fuel supply valve handle 12 and, hand operable rotary control handle 1 fixed to angularly disposed rotoary drive shaft 2, drive shaft 2 preferably being inserted through hole in control panel 10 drive shaft 2 having both ends supported on a bearing and being kept in place by collars, and having beveled gear wheel 3a, fixed to the end of drive shaft 2, opposite control handle 1; beveled gear wheel 3a which is to mesh in engagement with horizontally disposed rotary drive shaft 4, having both ends supported on a bearing and being kept in place by collars, and having gear wheel 3d, fixed to end of drive shaft 4, which is to mesh in engagement with gear wheel 3a, and horizontally disposed rotary drive shaft 4 having a beveled gear 3b, fixed to the center of drive shaft 4, about mid way over fuel tank 8, valve 7, handle 12, and beveled gear wheel 3c, which is to mesh in engagement with beveled gear 3b, and beveled gear wheel 3c, fixed to end of rotory operable drive shaft 5, and rotary operable drive shaft 5, extends downwardly being inserted through holes in supporting member 14, and operable drive shaft 5 having collars fixed to drive shaft above and below holes in supporting member 14 which is to keep drive shaft 5 and beveled gear 3c rotatably secured and in mesh engagement with beveled gear 3b operable drive shaft 5 is provided at its lower end with a clamp engaging means (hereafter referred to as socket) 6 for slidable engagement of fuel supply valve handle 12, socket 6 (herein shown in drawing 1 in the up position) from hand operable rotary control handle 1.

Referring now to drawing 3 it will be seen,

in FIG. 1A The invention as described above;
in FIG. 1B The invention as described above and in greater detail socket 6 and elongated grooves 5a, axially formed into the lower portion of operable drive shaft 5 so as to slidably in mesh age to corresponding axially formed elongated grooves into the interior circumferal side walls of through-hole 6b in socket 6, said elongated grooves being formed in a portion with a length of elongated grooves 16 over a length at least corresponding to the length of grooves 6b and corresponding grooves 5a so as to fully slidable engagalby in mesh said corresponding grooves.

The operable drive shaft 5 is inserted into the through-hole 6b from socket 6 for assembly, as shown in FIG. 1B and is connected at the lower end of operable drive shaft 5.

### Operation

The manner of using the gas barbecue grill with mechanism to control the fuel supply valve handle as so far described, it will be apparent that by hand operably rotating the control handle positioned near the barbecue control panel, the transmission of the rotation is thereby transferred through a plurality of rotatably, pivotably, slidably operable drive shafts, geared drive shafts, grooved drive shafts, beveled gears, and gears connected so as to contiguously transfer hand actuated rotating motion from the rotary control handle positioned near the barbecue control panel to the socket which is slidably engaged to the fuel supply valve handle, which thereby operably rotates the fuel supply valve handle variably to the open on and closed off position.

It will also be observed that there has been provided a compact unitary assembly which may be manufactured and installed as a unit in a portable barbecue grill, stand, oven, stationary and semi-stationary barbecue grills thus lending itself to a variety of types of installations.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept. In addition, the individual components need not be fabricated from the disclosed material, but could be fabricated from virtually any suitable material. Moreover, the individual components need not be formed in the disclosed shapes, or assembled in the disclosed configuration, but could be provided in virtually any shape, and assembled in virtually any configuration. Further, although many elements and components are described herein as physically separate modules, it will be manifest that they may be integrated into the apparatus with which it is associated. Furthermore, all the disclosed features of each disclosed embodiment can be combined with, or substituted for, the disclosed features of every other disclosed embodiment except where such features are mutually exclusive.

I hereby claim:

1. A gas barbecue grill with mechanism to control the fuel supply valve handle comprising:
a gas barbecue grill;
a fuel supply having an existing valve operated with a handle;
a hand operable rotary control handle located in or near the barbecue grill control panel;
a supporting cross member;
a plurality of rotatably, pivotably, slidably operable drive shafts, geared drive shafts, grooved drive shafts, beveled gear wheels, gear wheels, retainer collars, & bearings, a grooved socket through-hole, contiguously connected so as to contiguously transfer hand actuated rotating motion from the rotary control handle located near the barbecue control panel to the socket slidably engaged to the fuel supply valve handle, thereby operably rotating the fuel supply valve handle variably to the open on and closed off position; a socket formed so as to engage the fuel supply valve handle releaseably into the socket

2. The invention defined in claim 1, further including a flexible rotatable drive shaft so as to contiguously transfer hand actuated rotating motion from gas barbecue hand operable rotary control handle to the fuel supply valve handle. This claim is interpreted as if all of the language of claim 1 were incorporated.

3. The invention defined in claim 1, including a switched electric motor to operably drive the mechanism. This claim is interpreted as if all of the language of claim 1 were incorporated.

4. The invention defined in claim 1, including sockets uniquely formed so as to receive fuel
